(19) United States
(12) Patent Application Publication
(10) Pub. No.: US 2020/0142535 A1
(43) Pub. Date: May 7, 2020

(54) INPUT DEVICE FOR APPLYING TO A TOUCH DISPLAY DEVICE AND SIGNAL TRANSMITTING METHOD OF THE INPUT DEVICE RELATIVE TO A TOUCH DISPLAY DEVICE

(71) Applicant: ELAN MICROELECTRONICS CORPORATION, Hsinchu (TW)

(72) Inventors: Jyun-Yu CHEN, Hsinchu City (TW); Kun-Lin HSIEH, Pitou Township (TW)

(73) Assignee: ELAN MICROELECTRONICS CORPORATION, Hsinchu (TW)

(21) Appl. No.: 16/665,587

(22) Filed: Oct. 28, 2019

Related U.S. Application Data
(60) Provisional application No. 62/755,564, filed on Nov. 5, 2018.

(30) Foreign Application Priority Data
Apr. 18, 2019 (TW) 108113668

(51) Int. Cl. G06F 3/044; G06F 3/041

(52) U.S. Cl. CPC G06F 3/0442; G06F 3/04162

(57) ABSTRACT

An input device for applying to a touch display device is provided. In a sub-signal transmitting section of the input device, the input device transmits a modulation signal corresponding to the state information. Since the length of time of sub-signal transmitting section of the input device is larger or at least equal to one time the length of time of the display section of the touch display device plus twice the length of time of the blank section of the touch display device, the sub-signal transmitting section overlaps at least one of the blank section. The touch display device can receive the modulation signal transmitted from the input device during the overlapping blank sections. Thus, the input device does not need to know the frame of the touch display device so that a receiving unit is reduced to decrease the cost.

### CROSS-REFERENCE TO RELATED APPLICATIONS

This application claims the benefit of United States provisional application filed on Nov. 5, 2018 and having application Ser. No. 62/755,564, the entire contents of which are hereby incorporated herein by reference.

This application is based upon and claims priority under 35 U.S.C. 119 from Taiwan Patent Application No. 108113668 filed on Apr. 4, 2019, which is hereby specifically incorporated herein by this reference thereto.

### BACKGROUND OF THE INVENTION

### 1. Field of the Invention

The present invention relates to an input device and a signal transmitting method thereof, and more particularly to an input device applied to a touch display device.

### 2. Description of the Prior Arts

In current, in-cell touch display devices utilize a common electrode layer of a display panel as a touch sensing electrode, and therefore most of them utilize time division driving and touch scanning method and perform touch scanning or receive signals from an input device in blank sections of frames. As such, a user can perform touch operations by a finger or the input device. Accordingly, a two-way mode is widely used as the input devices (for example, a stylus) of the touch display devices. In other words, the input device does not only send a touch signal to the touch display device, but it also receives an uplink signal sent from the touch display device. Thus, when the input device transmits signals, the blank section of the touch display device can be synchronized with the input device, which helps the touch display device receive a downlink signal sent from the input device and obtain status information of the input device. In this way, the input device must have a corresponding receiving unit to receive the uplink signal sent by the touch display device, and the manufacturing cost of the input device is thus increased

### SUMMARY OF THE INVENTION

In view of the above, the present invention is directed to a touch sensing method which can solve the problems occurred when performing input operations on the touch panel device according to current techniques.

To achieve the above objects, the present invention provides a signal transmitting method of an input device relative to a touch display device, wherein the touch display device has a frame which has a time of length T_{F}, wherein the input device has a signal transmitting period which includes n sub-signal transmitting sections, and each of the sub-signal transmitting sections has a length of time T_{S}, wherein the frame of the touch display device includes multiple display sections and multiple blank sections, wherein each of the display sections has a length of time T_{D}, and each of the blank sections has a length of time T_{H}. The method comprising the following steps: the input device transmits a modulation signal to the touch display device in the sub-signal transmitting section of the signal transmitting period, wherein the modulation signal includes status information of the input device, and T_{S}≥T_{D}+2T_{H}, wherein nT_{S}≤T_{F}, and n is a positive integer; and the touch display device receives a modulation signal through a blank section corresponding to the sub-signal transmitting section that the input device transmits the modulation signal.

According to the present invention, an input device for a touch display device is also provided, wherein the touch display device has a frame of T_{F}, and the frame of the touch display device includes multiple display sections and multiple blank sections, wherein each of the display sections has a length of time T_{D}, and each of the blank sections has a length of time T_{H}. The input device includes: a body; a transmitting end, disposed at one end of the body and comprising a transmitting electrode; and a control unit, disposed in the body and comprising a signal transmitting circuit, connected to the transmitting electrode, wherein the signal transmitting circuit has a signal transmitting period that includes n sub-signal transmitting sections, and each of the sub-signal transmitting sections having a length of time T_{S}, wherein the control unit performs the following steps: the input device transmitting a modulation signal to the touch display device in the sub-signal transmitting section of the signal transmitting period, wherein the modulation signal includes status information of the input device, and T_{S}≥T_{D}+2T_{H}, wherein nT_{S}≤T_{F}, and n is a positive integer.

According to embodiments of the present invention, at least the following advantages can be achieved. By setting the length of time of the sub-signal transmitting section greater than or at least equal to one time a length of time of the display section plus twice the length of time of the blank section, the touch display device can still receive the modulation signal even though the signal transmitting period of the input device and the frame of the touch display device are not synchronized.

### BRIEF DESCRIPTION OF THE DRAWINGS

FIG. 1A shows an illustrative touch display device and an illustrative scheme of an input device in accordance with the present invention;

FIG. 1B shows block diagrams of portions of components of an input device in accordance with the present invention;

FIGS. 2A to 2C are illustrative schemes of the first embodiment of a controlling method in accordance with the present invention;

FIGS. 3A to 3C are illustrative schemes of the second embodiment of a controlling method in accordance with the present invention;

FIGS. 4A to 4C are illustrative schemes of the third embodiment of a controlling method in accordance with the present invention;

FIG. 5 is an illustrative scheme of the fourth embodiment of a controlling method in accordance with the present invention; and

FIG. 6 is an illustrative scheme of the fifth embodiment of a controlling method in accordance with the present invention.

### DETAILED DESCRIPTION OF THE EMBODIMENTS

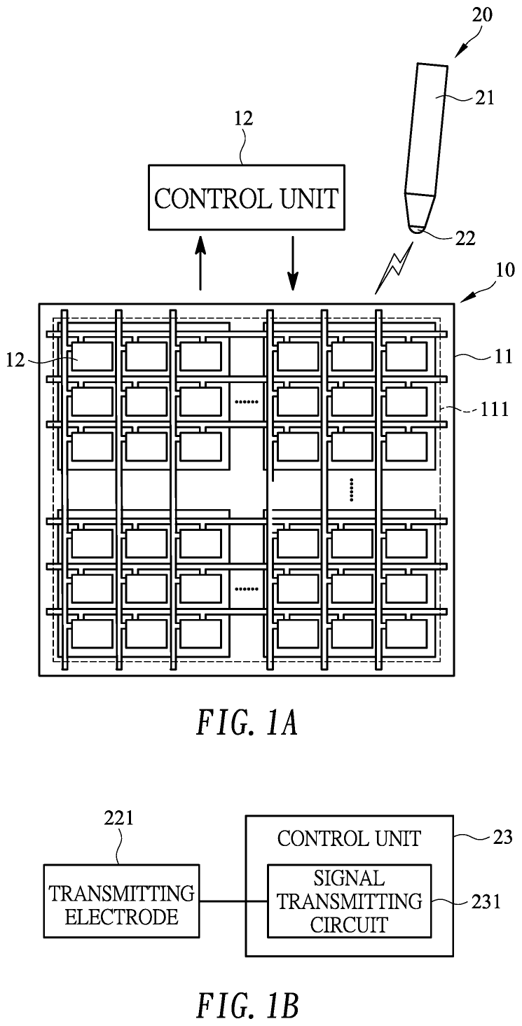

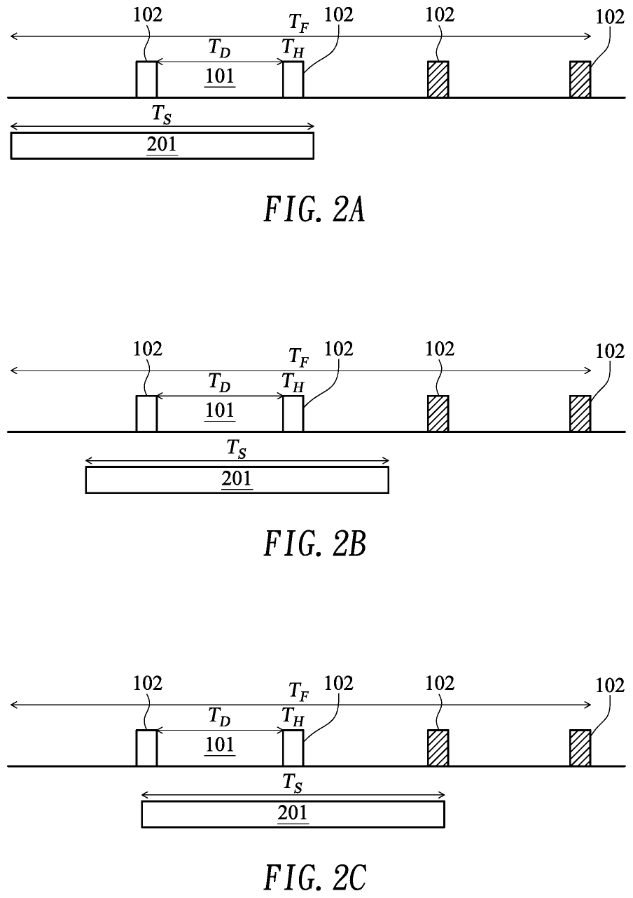

With reference to FIG. 1A, the touch display device 10 in accordance with the present invention mainly includes a display panel 11 and a control unit 12. The control unit 12 is electrically connected to the display panel 11 for controlling the display panel 11 to perform image display or touch detection. The display panel 11 mainly includes multiple thin-film transistors (not shown), a common electrode layer 111, and multiple pixel electrodes 112. The touch display device 10 has a frame. The control unit 12 executes multiple display sections and multiple blank sections in the frame. Each of the display sections is adjacent to a blank section. When the display section is executed, the pixel electrode 112 is applied with a voltage to form a voltage difference with the common electrode layer 111, and the voltage difference is used to control the flip angle of liquid crystal to determine the gray level or other colors shown by pixels, thereby displaying the image. When the blank section is subsequently executed, the modulation signal sent from the input device 20 is received by the common electrode layer 111, and the position information of the input device 20 is sensed by the capacitance change of the common electrode layer 111.

With reference to FIGS. 1A and 1B, the input device 20 includes a body 21, a transmitting end 22, and a control unit 23. The transmitting end 22 is disposed at one end of the body 21 and includes a transmitting electrode 221. The control unit 23 is disposed in the body 21 and has a signal transmitting circuit 231. The signal transmitting circuit 231 is connected to the transmitting electrode 221. The signal transmitting circuit 231 sends different modulation signals to represent different touch information based on the content of the touch information such as pressure value, identification, battery information, tilt angle, orientation, etc., through the transmitting electrode 221. For example, in one embodiment that the modulation signal represents 4-bit touch information, the modulation signal can be: A·sin(2πfᵢt), where the amplitude A is a constant, and i=0 to 15. The frequencies f₀ to f₁₅ can be 10 kHz to 160 kHz with an interval of 10 kHz between adjacent two frequencies. In another embodiment, the modulation signal can be: Ai·sin(2πf_{C}t), where the frequency f_{C} is a constant, and i=0 to 15. The amplitudes A₀ to A₁₅ can be 10 to 40 V with an interval of 2 V between adjacent two amplitudes. However, the present invention is not limited to these examples. When the touch display device 10 receives the modulation signal, the touch display device 10 may perform demodulation and determine the content of the touch information that is transmitted by the input device 20.

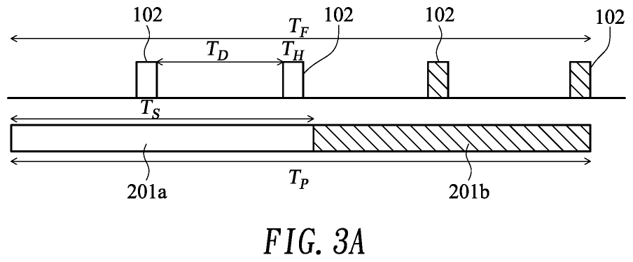

With reference to FIG. 2A, an embodiment of a method for the input device 20 performing touch sensing on the touch display device 10 in accordance to the present invention is described below. The frame of the touch sensing device 10 has a length of time T_{F}. Each of the display sections 101 has a length of time T_{D}. Each of blank sections 102 has a length of time T_{H}, and T_{H} is not less than the reciprocal of the aforementioned f₀ or the reciprocal of aforementioned f_{C}. In other words, the length of time of the blank section 102 is set to not less than the period time of the aforementioned modulation signal. The input device 20 has a signal transmitting period, and the signal transmitting period of the input device 20 has a length of time T_{P}. The signal transmitting period of the input device 20 includes n sub-signal transmitting sections 201, and each of the sub-signal transmitting sections 201 has a length of time T_{S}, where n is a positive integer. In the present embodiment, n=1. The sum of the lengths of time T_{S} of the sub-signal transmitting sections 201 of the input device 20 does not exceed the length of time T_{F} of the frame of the touch display device 10, i.e. nT_{S}≤T_{F}, and the length of time T_{S} of the sub-signal transmitting section 201 is larger than or at least equal to one time the length of time T_{D} of the display section 101 plus twice the length of time T_{H} of the blank section 102 (i.e., T_{S}≥T_{D}+2T_{H}). As such, no matter at what time the input device 20 starts to transmit signals in the sub-signal transmitting section 201, the sub-signal transmitting section 201 would overlap at least one of blank sections 102 so that the touch display device 10 successfully receives the modulation signal from the input device 20 through the blank section 102 that overlaps the sub-signal transmitting section 201. For example, according to the embodiment as shown in FIG. 2A, the start time of the sub-signal transmitting section 201 of the input device 20 exactly corresponds to the start time of the frame of the touch display device 10. The first and the second blank sections 102 overlap the sub-signal transmitting section 201. The touch display device 10 receives the modulation signal from the input device 20 in both of the first and the second blank sections 102. In the embodiment as shown in FIG. 2B, the start time of the sub-signal transmitting section 201 of the input device 20 is slightly later than the start time of the frame of the touch display device 10, but the first and second blank sections 102 still overlap the sub-signal transmitting section 201. Thus, the touch display device 10 receives the modulation signal from the input device 20 in both of the first and second blank sections 102 as well. In the embodiment as shown in FIG. 2C, the start time of the sub-signal transmitting section 201 of the input device 20 is slightly later than the start time of the first blank section 102 of the touch display device 10, which causes the first and the third blank sections 102 only partially overlap the sub-signal transmitting section 201, but the second blank section 102 still completely overlaps the sub-signal transmitting section 201. As such, the touch display device 10 can still receive the modulation signal from the input device 20 in the second blank section 102.

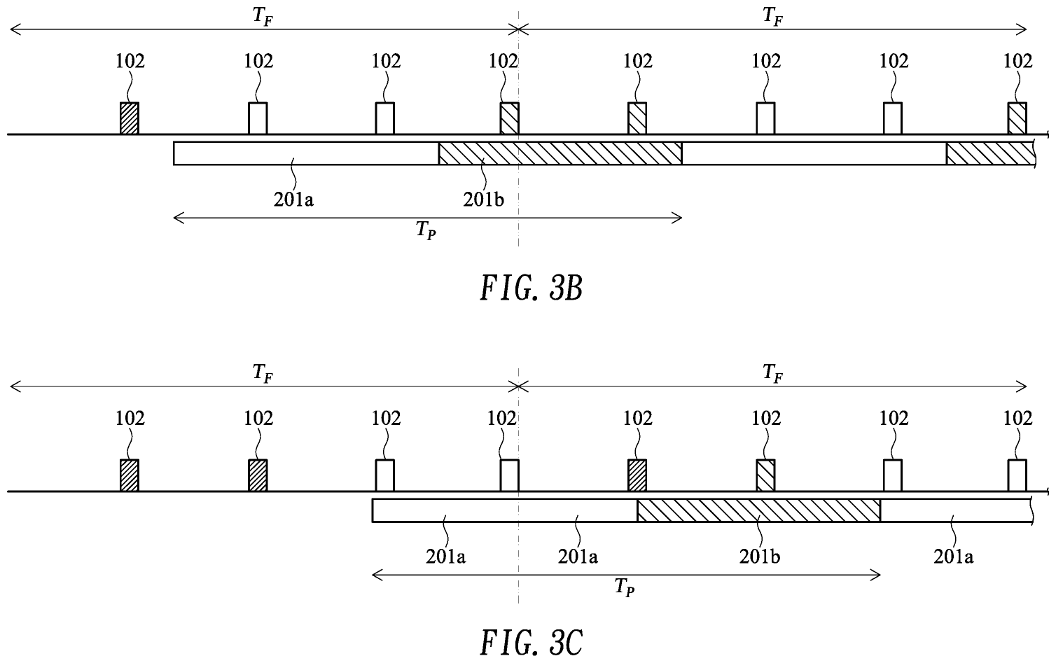

Furthermore, the length of time T_{P} of the signal transmitting period of the input device 20 may be equal to the length of time T_{F} of the frame of the touch display device 10, i.e. T_{P}=T_{F}. If the signal transmitting period of the input device 20 includes more than two sub-signal transmitting sections 201 (n is a positive integer larger than 1), more variation and more complicated touch information may be transmitted, wherein the time lengths of the sub-signal transmitting sections 201 may be the same or not the same. Referring to the embodiment as shown in FIG. 3A, n=2, and the signal transmitting period of the input device 20 includes two sub-signal transmitting sections 201a and 201b. The modulation signals with different modulation characteristics are transmitted in different sub-signal transmitting sections 201a and 201b. When the touch display device 10 receives the modulation signal, the touch display device 10 determines that the modulation signal is transmitted in which one of the sub-signal transmitting section 201a and 201b by identifying the modulation characteristics and then further demodulates the modulation signal to obtain the status information. For example, the modulation signal may be modulated in different frequency ranges. The different frequency ranges have different modulation characteristics. In the embodiment that the modulation signal represents 4-bit touch information, pressure information in the status information is transmitted in the first sub-signal transmitting section 201a. Tilt angle information in the status information is transmitted in the second sub-signal transmitting section 201b. The modulation signal may be: A·sin(2πfᵢt). The amplitude A is a constant. In the first sub-signal transmitting section 201a, i=0 to 15, and the frequencies f₀ to f₁₅ may be 10 kHz to 160 kHz with an interval of 10 kHz between two adjacent frequencies. In the second sub-signal transmitting section 201b, i=16 to 31, and the frequencies f₁₀ to f₃₁ may be 200 kHz to 500 kHz with an interval of 20 kHz between two adjacent frequencies. The touch display device 10 has a demodulation circuit, and the demodulation circuit has a modulation characteristic table. When the touch display device 10 receives the modulation signal, the touch display device 10 demodulates the modulation signal and obtains the corresponding status information through the demodulation circuit. If the modulation characteristic has a frequency between 10 kHz and 160 kHz, it can be known that the modulation signal is transmitted in the first sub-signal transmitting section 201a, i.e. a pressure message. The content of the pressure information transmitted by the input device 20 may be obtained after demodulation. If the modulation characteristic has a frequency between 200 kHz and 500 kHz, it can be known that the modulation signal transmitted in the second sub-signal transmitting section 201b, i.e. tilt angle information. The content of the tilt angle information transmitted by the input device 20 may be obtained after demodulation. In another embodiment, the modulation signal may also be modulated in different amplitude ranges, but is not limited thereto.

In this embodiment, since there is a limitation of T_{S}≥T_{D}+2T_{H}, the first and second sub-signal transmitting sections 201a, 201b overlap at least one of the blank sections 102 no matter when the input device 20 starts to execute the first sub-signal transmitting section 201a. Accordingly, the touch display device 10 can successfully receive the modulation signal from the input device 20 through the blank section 102 that overlaps the first and second sub-signal transmitting sections 201a and 201b. For example, in an embodiment shown in FIG. 3A, the start time of the first sub-signal transmitting section 201a of the input device 20 is exactly the same as the start time of the frame of the touch display device 10, and the first and second blank sections 102 overlap the first sub-signal transmitting section 201a. The touch display device 10 receives the modulation signal from the first sub-signal transmitting section 201a of the input device 20 in both of the first and second blank sections 102. The second sub-signal transmitting section 201b overlaps the third and fourth blank sections 102, and the touch display device 10 receives the modulation signal from the second sub-signal transmitting section 201b of the input device 20 in the third and fourth blank sections 102. In the embodiment shown in FIG. 3B, the start time of the first sub-signal transmitting section 201a of the input device 20 is slightly later than the start time of the frame of the touch display device 10, and the second and the third blank sections 102 still overlap the first sub-signal transmitting section 201a. Accordingly, the touch display device 10 successfully receives the modulation signal from the first sub-signal transmitting section 201a of the input device 20 in both of the second and third blank sections 102. Since the frames of the touch display device are continuously executed and the signal transmitting periods of the input device are also continuously executed, the second sub-signal transmitting section 201b overlaps the fourth blank section 102 of the current frame and the first blank section 102 of the next frame. The touch display device 10 receives the modulation signal from the second sub-signal transmitting section 201b of the input device 20 in the fourth blank section 102 of the current frame and the first blank section 102 of the next frame. In the embodiment shown in FIG. 3C, the start time of the first sub-signal transmitting section 201a of the input device 20 is later than the end time of the second blank section 102 of the frame of the touch display device 10, and the third and fourth blank sections 102 still overlap the first sub-signal transmitting section 201a. Accordingly, the touch display device 10 successfully receives the modulation signal from the first sub-signal transmitting section 201a of the input device 20 in both of the third and fourth blank sections 102. Since the frames of the first device 10 are continuously executed, and the signal transmitting periods of the input device 20 are also continuously executed, the first sub-signal transmitting section 201a and the second sub-signal transmitting section 201b partially overlap the first blank section 102 of the next frame. The first blank section 102 does not completely receive the modulation signal sent from the second sub-signal transmitting section 201b of the input device 20. However, the second sub-signal transmitting section 201b still overlaps the second blank section 102 of the next frame, and the touch display device 10 still receives the modulation signal from the second sub-signal transmitting section 201b of the input device 20 in the second blank section 201b of the next frame.

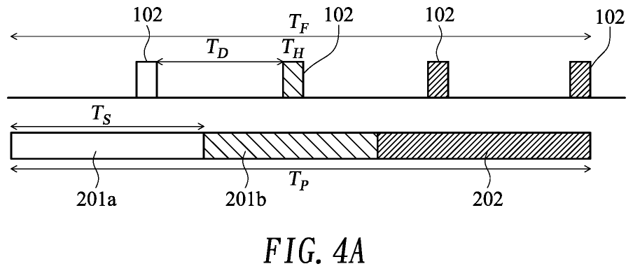

Referring to embodiments as shown in FIGS. 4A, 4B and 4C, in addition to aforementioned sub-signal transmitting sections 201a, 201b, the signal transmitting period of the input device 20 has an idle section 202. In the idle section 202, the input device 20 does not transmit the modulation signal to reduce power consumption. Based on the limitation of T_{S}≥T_{D}+2T_{H}, it can be seen from the embodiments shown in FIGS. 4A, 4B and 4C that each of the sub-signal transmitting sections 201a, 201b still overlaps at least one of the blank sections 102 so that the touch display device 10 receives the transmitted modulation signal, regardless of the length of the idle section 202, the relationship between the start time of the sub-signal transmitting sections 201a, 201b and the start time of frame of the touch display device 10.

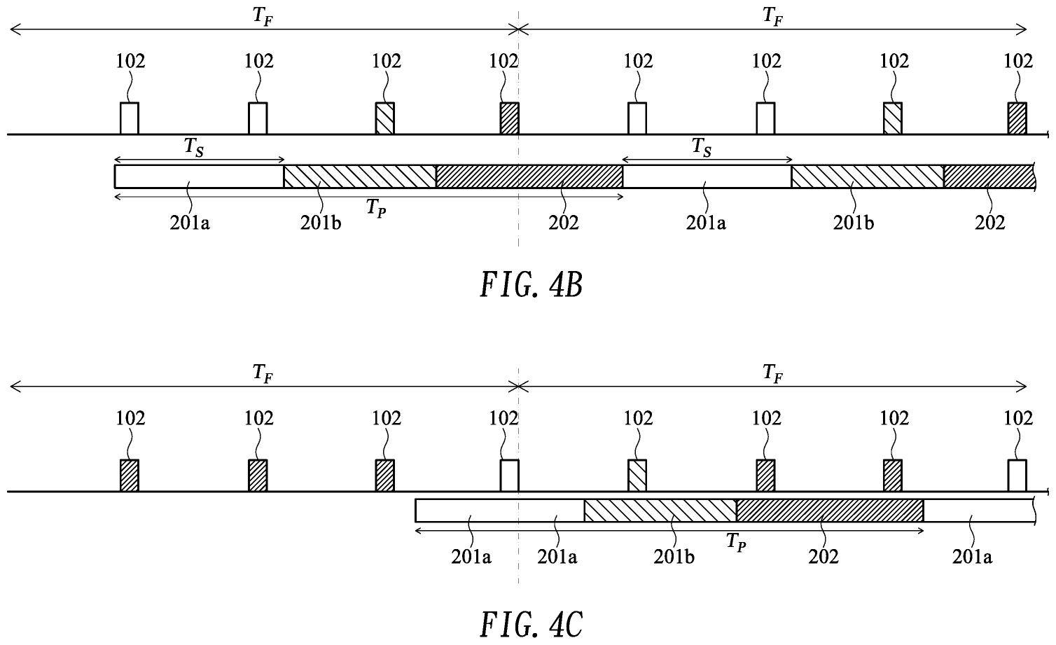

Referring to the embodiment as shown in FIG. 5, the signal transmitting period of the input device 20 further includes a lead section 203. A beacon signal is transmitted in the lead section 203. The beacon signal is not altered with changes of the status information. The beacon signal is used as an indication message. For example, the beacon signal indicates a beginning section of the signal transmitting period. The beacon signal at least includes an indication signal of a preset frequency or an indication signal of a preset amplitude. For example, in an embodiment, the beacon signal may be an indication signal having a constant frequency of 5 kHz or a constant amplitude of 5 V. In another embodiment, the beacon signal may be selected from a preset form that includes signals of different frequencies or different amplitudes.

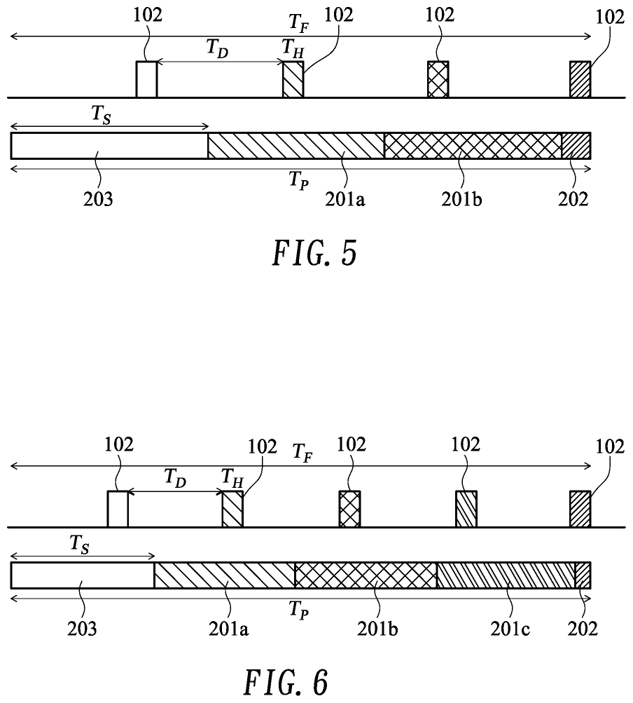

Referring to the embodiment as shown in FIG. 6, the signal transmitting period of the input device 20 may have a lead section 203, multiple sub-signal transmitting sections 201a, 201b, 201c, and an idle section 202. A beacon signal is transmitted in the lead section 203. The modulation signals with different characteristics are transmitted in the sub-signal transmitting sections 201a, 201b, 201c, and no signals are transmitted in the idle section 202.

When the lead section 203 exists, the touch display device 10 can clearly know the start of each signal transmitting period of the input device 20 through the lead section 203. Thus, the signal transmitting period of the input device 20 can be divided into more sub-signal transmitting sections and reduce the bit numbers that are needed to be transmitted in each sub-signal transmitting section to reduce the usage amount of the frequencies or the amplitudes. For example, in an embodiment that a total of 8 bits of signal are transmitted, if the signal transmitting period of the input device 20 has two sub-signal transmitting sections, and each of the sub-signal transmitting sections is responsible for transmitting signals of 4 bits. Each of the sub-signal transmitting section needs to use 16 (2⁴) frequencies or amplitudes, and a total of 32 (16*2) frequencies or amplitudes are needed. However, if a method of this embodiment is implemented, the signal transmitting period of the input device 20 has eight sub-signal transmitting sections. Each sub-signal transmitting section only needs to use 2 (2¹) frequencies or amplitudes, and only 16 frequencies or amplitudes need to be used in total. When the preset frequency of the lead section 203 is added, the total number of frequencies is 17 so that the bandwidth needs can be effectively reduced.

Thus, by setting the length of time of the sub-signal transmitting section 201 larger than or at least equal to one time the length of time of the display section 101 plus twice the length of time of the blank section 102, the signal transmitting period of the input device does not need to be synchronized with the frame of the touch display device. Then even though the signal transmitting period of the input device 20 and the frame of the touch display device 10 are not synchronized, the touch display device 10 can still receive the modulation signal.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A signal transmitting method of an input device relative to a touch display device, wherein the touch display device has a frame which has a time of length T_{F}, wherein the input device has a signal transmitting period which comprises n sub-signal transmitting sections, and each of the sub-signal transmitting sections has a length of time T_{S}, wherein the frame of the touch display device comprises multiple display sections and multiple blank sections, wherein a length of time of each of the display sections is T_{D}, and each of the blank sections has a length of time T_{H}, the method comprising the following steps:
transmitting a modulation signal to the touch display device by the input device in the sub-signal transmitting section of the signal transmitting period, wherein the modulation signal comprises status information of the input device, and T_{S}≥T_{D}+2T_{H}, wherein nT_{S}≤T_{F}, and n is a positive integer; and
receiving the modulation signal by the touch display device through the blank section corresponding to the sub-signal transmitting section that the input device transmits the modulation signal.

2. The method as claimed in claim 1, wherein n is a positive integer greater than 1, and the modulation signals includes a first modulation signal and a second modulation signal, the first and the second modulation signal have different modulation characteristics respectively, wherein the first modulation signal is transmitted to the touch display device in one of the sub-signal transmitting sections of the signal transmitting period, the second modulation signal is transmitted to the touch display device in another one of the sub-signal transmitting sections of the signal transmitting period.

3. The method as claimed in claim 2, wherein the different modulation characteristics of the modulation signals comprise performing signal modulation with different frequencies or performing signal modulation with different amplitudes.

4. The method as claimed in claim 1, wherein the signal transmitting period of the input device further comprises an idle section, and the input device does not transmit the modulation signal in the idle section.

5. The method as claimed in claim 1, wherein the sub-signal transmitting period of the input device further comprises a lead section, and the input device transmits a beacon signal having at least one preset frequency or having at least one preset amplitude in the lead section.

6. The method as claimed in claim 1, wherein, each blank section is adjacent to at least one of the display sections in the frame of the touch display section.

7. The method as claimed in claim 1, a length of time of the signal transmitting period is T_{P}, and T_{P}=T_{F}.

8. An input device for a touch display device, wherein the touch display device has a frame of T_{F}, and the frame of the touch display device comprises multiple display sections and multiple blank sections, wherein each of the display sections has a length of time T_{D}, and each of the blank sections has a length of time T_{H}, the input device comprising:
a body;
a transmitting end, disposed at one end of the body and comprising a transmitting electrode; and
a control unit, disposed in the body and comprising a signal transmitting circuit connected to the transmitting electrode;
wherein the signal transmitting circuit has a signal transmitting period that comprises n sub-signal transmitting sections, and each of the sub-signal transmitting sections has a length of time T_{S}, wherein the control unit performs the following steps:
the signal transmitting circuit of the input device transmitting a modulation signal to the touch display device in the sub-signal transmitting section of the signal transmitting period, wherein the modulation signal comprises status information of the input device, and T_{S}≥T_{D}+2T_{H}, wherein nT_{S}≤T_{F}, and n is a positive integer.

9. The input device as claimed in claim 8, wherein n is a positive integer greater than 1, and the modulation signals includes a first modulation signal and a second modulation signal, the first and the second modulation signal have different characteristics respectively, wherein the first modulation signal is transmitted to the touch display device in one of the sub-signal transmitting sections of the signal transmitting period, the second modulation signal is transmitted to the touch display device in another one of the sub-signal transmitting sections of the signal transmitting period.

10. The input device as claimed in claim 9, wherein the different modulation characteristics of the modulation signals comprise performing signal modulation with different frequencies or performing signal modulation with different amplitudes.

11. The input device as claimed in claim 8, wherein the signal transmitting period of the input device further comprises an idle section, and the input device does not transmit the modulation signal in the idle section.

12. The input device as claimed in claim 9, wherein the signal transmitting period of the input device further comprises an idle section, and the input device does not transmit the modulation signal in the idle section.

13. The input device as claimed in claim 10, wherein the signal transmitting period of the input device further comprises an idle section, and the input device does not transmit the modulation signal in the idle section.

14. The input device as claimed in claim 8, wherein the sub-signal transmitting period of the input device further comprises a lead section, and the input device transmits a beacon signal having at least one preset frequency or having at least one preset amplitude in the lead section.

15. The input device as claimed in claim 9, wherein the sub-signal transmitting period of the input device further comprises a lead section, and the input device transmits a beacon signal having at least one preset frequency or having at least one preset amplitude in the lead section.

16. The input device as claimed in claim 10, wherein the sub-signal transmitting period of the input device further comprises a lead section, and the input device transmits a beacon signal having at least one preset frequency or having at least one preset amplitude in the lead section.

17. The input device as claimed in claim 8, a length of time of signal transmitting period of the input device is T_{P}, and T_{P}=T_{F}.

18. The input device as claimed in claim 9, a length of time of signal transmitting period of the input device is T_{P}, and T_{P}=T_{F}.

19. The input device as claimed in claim 10, a length of time of signal transmitting period of the input device is T_{P}, and T_{P}=T_{F}.
